(19) United States
(12) Patent Application Publication
(10) Pub. No.: US 2020/0313250 A1
(43) Pub. Date: Oct. 1, 2020

(54) SYSTEM, METHOD, AND APPARATUS FOR INHIBITING COMBUSTION

(71) Applicant: LENOVO (Singapore) PTE. LTD., New Tech Park (SG)

(72) Inventors: Robert James Norton, JR., Raleigh, NC (US); Hiran Samarthyam Haranatha Babu, Raleigh, NC (US); Jacob Yates Barger, Durham, NC (US); Robert James Kapinos, Durham, NC (US)

(21) Appl. No.: 16/367,206

(22) Filed: Mar. 27, 2019

(51) Int. Cl. H01M 10/52; H01M 2/10

(52) U.S. Cl. CPC H01M 10/523; H01M 2200/10; H01M 2/1022

(57) ABSTRACT

Apparatuses, methods, and systems are disclosed for inhibiting combustion. One system includes a battery and a combustion inhibiting device disposed adjacent to the battery. The combustion inhibiting device includes a material forming an enclosure. The material is configured to at least partially melt if a temperature of the material is greater than a threshold temperature. The combustion inhibiting device also includes an oxygen absorber sealed inside the enclosure to inhibit oxygen external to the combustion inhibiting device from contacting the oxygen absorber. In response to the material of the combustion inhibiting device at least partially melting, the oxygen absorber is configured to absorb oxygen external to the combustion inhibiting device to inhibit combustion.

### FIELD

The subject matter disclosed herein relates to batteries and more particularly relates to inhibiting combustion of batteries.

### BACKGROUND

### Description of the Related Art

Information handling devices, such as desktop computers, laptop computers, tablet computers, smart phones, optical head-mounted display units, smart watches, televisions, streaming devices, etc., are ubiquitous in society. These information handling devices may include one or more batteries. Such batteries, or other batteries, may be susceptible to combustion.

### BRIEF SUMMARY

A system for inhibiting combustion is disclosed. A method and apparatus also perform the functions of the system. In one embodiment, the system includes a battery and a combustion inhibiting device disposed adjacent to the battery. In certain embodiments, the combustion inhibiting device includes a material forming an enclosure. In some embodiments, the material is configured to at least partially melt if a temperature of the material is greater than a threshold temperature. In various embodiments, the combustion inhibiting device also includes an oxygen absorber sealed inside the enclosure to inhibit oxygen external to the combustion inhibiting device from contacting the oxygen absorber. In such embodiments, in response to the material of the combustion inhibiting device at least partially melting, the oxygen absorber is configured to absorb oxygen external to the combustion inhibiting device to inhibit combustion.

In some embodiments, the system includes an information handling device having the battery and the combustion inhibiting device. In one embodiment, the information handling device is selected from a group including a phone, a computer, and a tablet.

In various embodiments, the system includes a container. In such embodiments, the battery and the combustion inhibiting device are disposed inside the container. In some embodiments, the combustion inhibiting device is positioned around the battery.

A method for inhibiting combustion, in one embodiment, includes forming an enclosure of a combustion inhibiting device from a material configured to at least partially melt if a temperature of the material is greater than a threshold temperature. In certain embodiments, the method includes disposing an oxygen absorber inside the enclosure. In some embodiments, the method includes sealing the enclosure to inhibit oxygen external to the combustion inhibiting device from contacting the oxygen absorber. In such embodiments, in response to the material of the combustion inhibiting device at least partially melting, the oxygen absorber is configured to absorb oxygen external to the combustion inhibiting device to inhibit combustion.

In some embodiments, the material is non-porous. In various embodiments, the threshold temperature is greater than 100 degrees Celsius and less than 500 degrees Celsius. In one embodiment, disposing the oxygen absorber inside the enclosure includes substantially filling the enclosure with the oxygen absorber.

In some embodiments, sealing the enclosure includes substantially inhibiting the oxygen absorber from absorbing oxygen until the material of the combustion inhibiting device at least partially melts. In certain embodiments, sealing the enclosure includes applying an adhesive to an open side of the enclosure.

In some embodiments, sealing the enclosure includes applying heat to an open side of the enclosure. In various embodiments, sealing the enclosure includes adding the material to an open side of the enclosure. In certain embodiments, sealing the enclosure includes vacuum sealing the enclosure.

In one embodiment, an apparatus for inhibiting combustion includes a material forming an enclosure. In such an embodiment, the material is configured to at least partially melt if a temperature of the material is greater than a threshold temperature. In certain embodiments, the apparatus includes an oxygen absorber sealed inside the enclosure to inhibit oxygen external to the apparatus from contacting the oxygen absorber. In such embodiments, in response to the material of the apparatus at least partially melting, the oxygen absorber is configured to absorb oxygen external to the apparatus to inhibit combustion.

In certain embodiments, the material is non-porous. In one embodiment, the threshold temperature is greater than 100 degrees Celsius and less than 500 degrees Celsius. In certain embodiments, the oxygen absorber substantially fills the enclosure. In various embodiments, the enclosure substantially inhibits the oxygen absorber from absorbing oxygen until the material of the apparatus at least partially melts. In some embodiments, the oxygen absorber is selected from a group comprising a liquid, a powder, and a plurality of pellets.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for inhibiting combustion;

FIG. 2 is a schematic block diagram illustrating one embodiment of an apparatus including an information handling device;

FIG. 3 is a schematic block diagram illustrating one embodiment of an apparatus including a combustion inhibiting device;

FIG. 4 is a schematic block diagram illustrating one embodiment of a system for manufacturing a combustion inhibiting device;

FIG. 5 is a schematic block diagram illustrating another embodiment of an apparatus including a combustion inhibiting device;

FIG. 6 is a schematic block diagram illustrating one embodiment of a system including a combustion inhibiting device; and

FIG. 7 is a schematic flow chart diagram illustrating an embodiment of a method for manufacturing a combustion inhibiting device.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

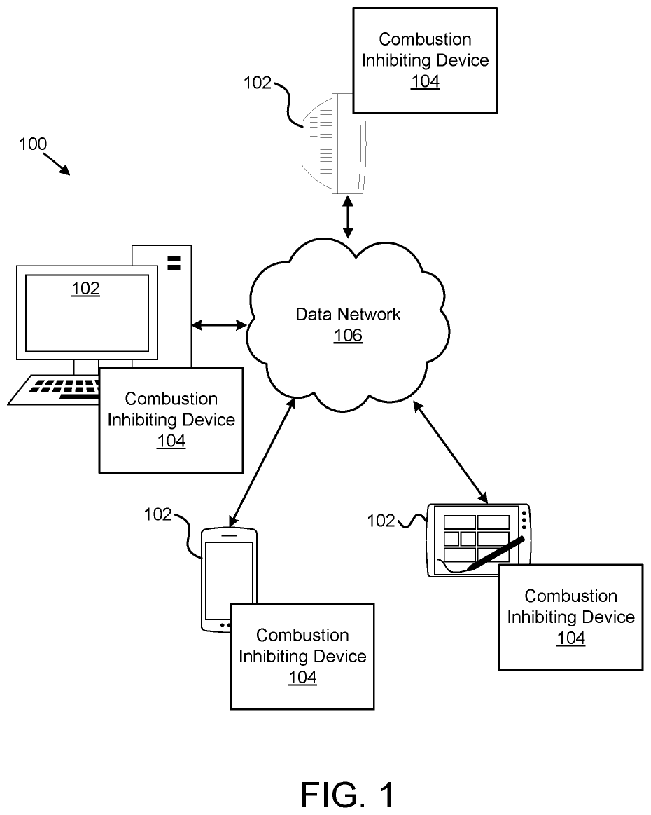

FIG. 1 depicts one embodiment of a system 100 for inhibiting combustion. In one embodiment, the system 100 includes information handling devices 102, combustion inhibiting devices 104, and data networks 106. Even though a specific number of information handling devices 102, combustion inhibiting devices 104, and data networks 106 are depicted in FIG. 1, one of skill in the art will recognize that any number of information handling devices 102, combustion inhibiting devices 104, and data networks 106 may be included in the system 100.

In one embodiment, the information handling devices 102 include computing devices, such as desktop computers, laptop computers, personal digital assistants (PDAs), tablet computers, smart phones, cellular phones, smart televisions (e.g., televisions connected to the Internet), set-top boxes, game consoles, security systems (including security cameras), vehicle on-board computers, network devices (e.g., routers, switches, modems), streaming devices, or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the combustion inhibiting device 104. In certain embodiments, the combustion inhibiting device 104 may include a material forming an enclosure. In such embodiments, the material may be configured to at least partially melt if a temperature of the material is greater than a threshold temperature. The combustion inhibiting device 104 may include an oxygen absorber sealed inside the enclosure to inhibit oxygen external to the combustion inhibiting device 104 from contacting the oxygen absorber. Moreover, in response to the material of the combustion inhibiting device 104 at least partially melting, the oxygen absorber may be configured to absorb oxygen external to the combustion inhibiting device 104 to inhibit combustion. In this manner, the combustion inhibiting device 104 may be used for inhibiting combustion.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

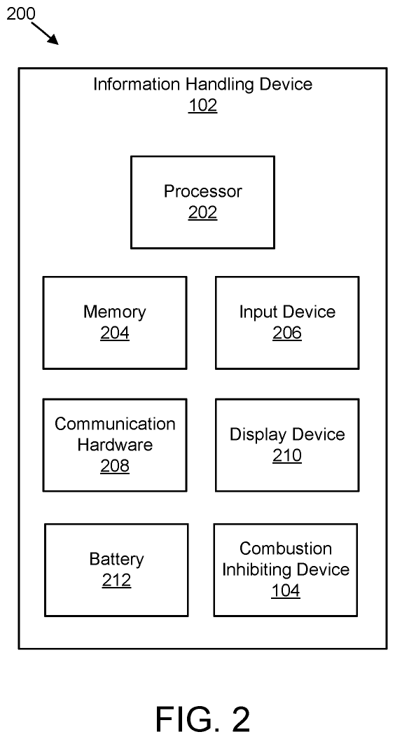

FIG. 2 depicts one embodiment of an apparatus 200 that may be used for inhibiting combustion. The apparatus 200 includes one embodiment of the information handling device 102. Furthermore, the information handling device 102 may include the combustion inhibiting device 104, a processor 202, a memory 204, an input device 206, communication hardware 208, a display device 210, and a battery 212. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the combustion inhibiting device 104, the input device 206, the communication hardware 208, and the display device 210.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores program code and related data, such as an operating system or other controller algorithms operating on the information handling device 102.

The battery 212 may include any suitable type of battery or group of batteries used to provide power to the information handling device 102. For example, the battery 212 may include a rechargeable battery, a nickel cadmium battery, a nickel metal hydride battery, a lithium ion battery, and/or another type of battery.

The information handling device 102 may use the combustion inhibiting device 104 for inhibiting combustion, such as for inhibiting combustion of the battery 212. As may be appreciated, the combustion inhibiting device 104 may include any suitable materials for inhibiting combustion. In one embodiment, the combustion inhibiting device 104 may be placed around the battery 212 to inhibit combustion of the battery. In another embodiment, the combustion inhibiting device 104 may be positioned so that the combustion inhibiting device 104 touches at least a portion of the battery 212. In some embodiments, the combustion inhibiting device 104 may be positioned near the battery 212. Accordingly, if the battery 212 temperature passes a threshold temperature, the combustion inhibiting device 104 may be activated so that an oxygen absorber of the combustion inhibiting device 104 is exposed to air around the battery 212 to quickly remove oxygen from the air to inhibit combustion that may result from the battery 212 becoming too hot.

The input device 206, in one embodiment, may include any known computer input device including a touch panel, a button, a keyboard, a stylus, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202.

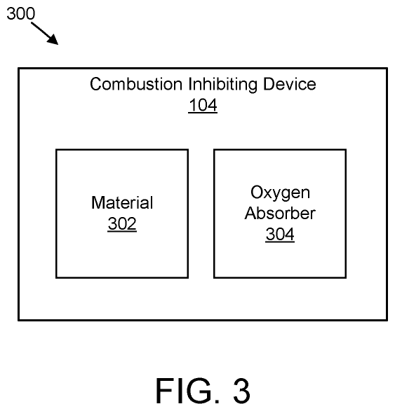

FIG. 3 depicts a schematic block diagram illustrating one embodiment of an apparatus 300 that includes one embodiment of the combustion inhibiting device 104. Furthermore, the combustion inhibiting device 104 includes a material 302 and an oxygen absorber 304.

In certain embodiments, the material 302 forms an enclosure for the combustion inhibiting device 104 to hold the oxygen absorber 304 inside the material 302. The enclosure may form a pouch that is substantially flat except for the thickness of the oxygen absorber 304 within the enclosure. As may be appreciated, the oxygen absorber 304 may be the only thing placed within the enclosure. Dimensions of the enclosure may be any suitable dimensions, such as being based on a size of a battery corresponding to the combustion inhibiting device 104. In other words, the dimensions of the combustion inhibiting device 104 may correspond directly to a size of a battery for which the combustion inhibiting device 104 is used to inhibit combustion. In some embodiments, the dimensions of the combustion inhibiting device 104 may correspond to a size of a container in which a battery and the combustion in habiting device 104 are placed (e.g., related to an amount of oxygen available for combustion within a container).

The material 302 is configured to at least partially melt if a temperature of the material 302 is greater than a threshold temperature. Upon at least partially melting, the oxygen absorber 304 is released and/or exposed to air outside the material 302 so that oxygen can be quickly absorbed from the air to inhibit combustion. As may be appreciated, the material 302 is a non-porous material that inhibits oxygen from passing through the material 302. Accordingly, the only oxygen that the oxygen absorber 304 has contact with is oxygen that is sealed within the material 302. In some embodiments, the material 302 may include a polymer, such as a soft, semi-soft, or hard polymer. In various embodiments, the material 302 may be formed so that it is non-flammable, does not burn, and/or melts at temperatures less than approximately 300 degrees Celsius, 500 degrees Celsius, and/or 800 degrees Celsius. In some embodiments, the material 302 will at least partially melt if a temperature of the material is greater than the threshold temperature. In one embodiment, the threshold temperature may be greater than 100 degrees Celsius and less than 500 degrees Celsius.

In one embodiment, the oxygen absorber 304 is sealed inside the enclosure formed by the material 302 to inhibit oxygen external to the combustion inhibiting device 104 from contacting the oxygen absorber 304. In other words, the only oxygen that the oxygen absorber 304 contacts within the sealed enclosure is oxygen that is sealed in the enclosure with the oxygen absorber 304. In some embodiments, the enclosure is sealed using a vacuum seal that removes most, a substantial portion, and/or all air and oxygen from the enclosure at the time the enclosure is sealed.

In response to the material 302 of the combustion inhibiting device 104 at least partially melting, the oxygen absorber 304 is configured to absorb oxygen external to the combustion inhibiting device 104 to inhibit combustion. In certain embodiments, the oxygen absorber 304 substantially fills the enclosure to use up any available space within the enclosure and to reduce an amount of oxygen sealed within the enclosure. As may be appreciated, the enclosure substantially inhibits the oxygen absorber 304 from absorbing oxygen until the material 302 of the combustion inhibiting device 104 at least partially melts. In other words, the material 302 of the enclosure inhibits oxygen from passing through the material 302. The oxygen absorber 304 is intended to be substantially unused until the material 302 melts and/or is punctured.

In various embodiments, the oxygen absorber 304 may have a form including a liquid, a powder, and/or pellets. As may be appreciated, if the oxygen absorber 304 is a liquid, the liquid may flow out of the material 302 in response to the material 302 melting. Furthermore, if the oxygen absorber 304 is a powder and/or pellets, the oxygen absorber 304 may be dispersed in response to the material 302 melting. The oxygen absorber 304 may be any suitable type of oxygen absorber and/or oxygen scavenger that removes and/or decreases a level of oxygen. For example, the oxygen absorber 304 may include a concentrated acidic acid, an alkaline solution, a pyrogallic acid, an iron powder, an ascorbate, a sodium hydrogen carbonate, a citrus based compound, and/or a sodium chloride.

In certain embodiments, the material 302 may be designed not to melt, but instead may include a temperature sensor used to detect a temperature at the material 302. In such embodiments, if the detected temperature passes a threshold temperature, the material 302 may open using a mechanical device, an electronic device, or a property of the material 302 to release the oxygen absorber 304 to inhibit combustion.

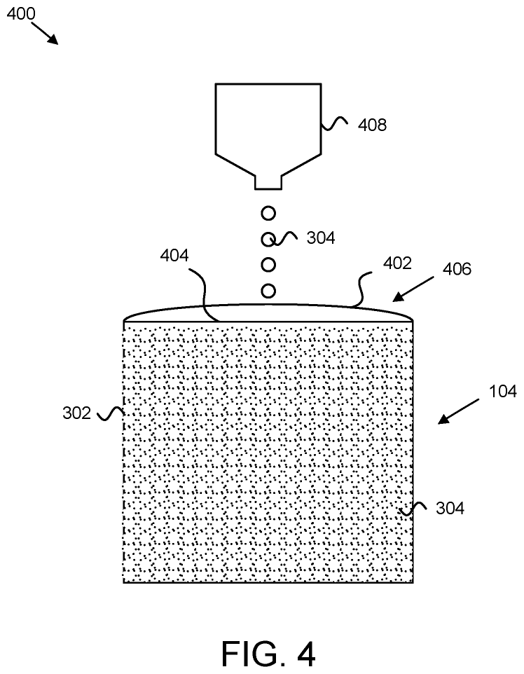

FIG. 4 is a schematic block diagram illustrating one embodiment of a system 400 for manufacturing the combustion inhibiting device 104. The system 400 is used to fill the material 302 with the oxygen absorber 304. The material 302 forms an enclosure (e.g., pouch) having a first upper side 402 and a second upper side 404 that form an opening 406 on the upper end of the enclosure. A dispenser 408 disposes the oxygen absorber 304 into the opening 406 of the enclosure. As illustrated, the oxygen absorber 304 substantially fills (e.g., fills a majority of the enclosure, leaves little remaining space) the enclosure. After the oxygen absorber 304 is disposed in the enclosure, the first upper side 402 and the second upper side 404 are sealed together to secure the oxygen absorber 304 inside the enclosure and to substantially inhibit the oxygen absorber 304 from absorbing oxygen external to the enclosure until the material 302 of the combustion inhibiting device 104 at least partially melts. In some embodiments, the first upper side 402 and/or the second upper side 404 include sealing elements that enable the first upper side 402 to be pressed to the second upper side 404 to seal the enclosure. In other embodiments, the first upper side 402 may be sealed to the second upper side 404 using any suitable method.

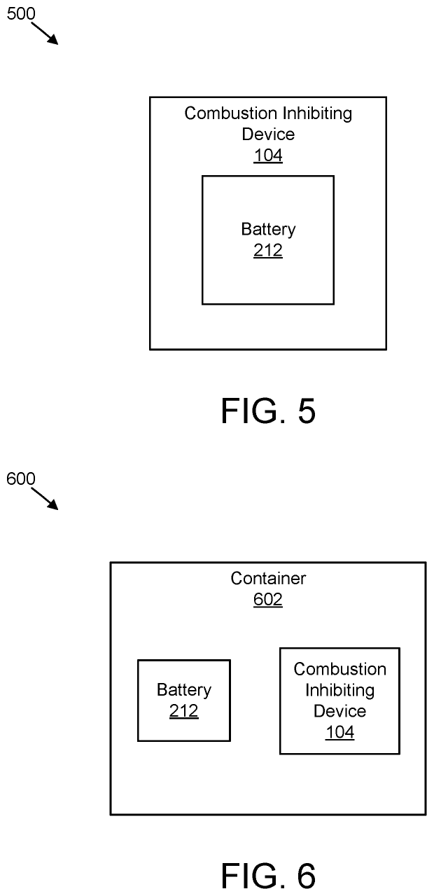

FIG. 5 is a schematic block diagram illustrating another embodiment of an apparatus 500 including the combustion inhibiting device 104. As illustrated, the combustion inhibiting device 104 is positioned to surround the entire battery 212, to surround a substantial portion (e.g., majority, greater than 50%) of the battery 212, and/or to contact at least part of the battery 212. Accordingly, in response to the material 302 of the combustion inhibiting device 104 passing a threshold temperature that results in the material 302 at least partially melting, the oxygen absorber 304 of the combustion inhibiting device 104 is released to remove oxygen from areas around the battery 212 to inhibit combustion resulting from temperatures of the battery 212. In some embodiments, the battery 212 may be a single cell of a larger battery and the combustion inhibiting device 104 may be used for only the single cell. Moreover, in such embodiments, one or more cells of the larger battery may have a corresponding combustion inhibiting device 104. In certain embodiments, the battery 212 may be a multi cell battery and the combustion inhibiting device 104 may be used for the entire battery.

FIG. 6 is a schematic block diagram illustrating one embodiment of a system 600 including the combustion inhibiting device 104. The system 600 includes a container 602 that holds the battery 212 and the combustion inhibiting device 104. In some embodiments, the battery 212 and the combustion inhibiting device 104 are disposed inside the container 602. The container 602 may be any suitable type of container, such as a box used for shipping the battery, a box used to store the battery 212 on a shelf, and/or another type of container 602. In one embodiment, the container 602 is a box in which the battery 212 and the combustion inhibiting device 104 are placed to be near one another. The container 602 is sealed so that there is a limited amount of oxygen within the container 602. Accordingly, if the temperature of the battery 212 exceeds a threshold temperature that results in melting (or otherwise activating) the combustion inhibiting device 104, the combustion inhibiting device 104 releases the oxygen absorber 304 to inhibit combustion resulting from a temperature of the battery 212.

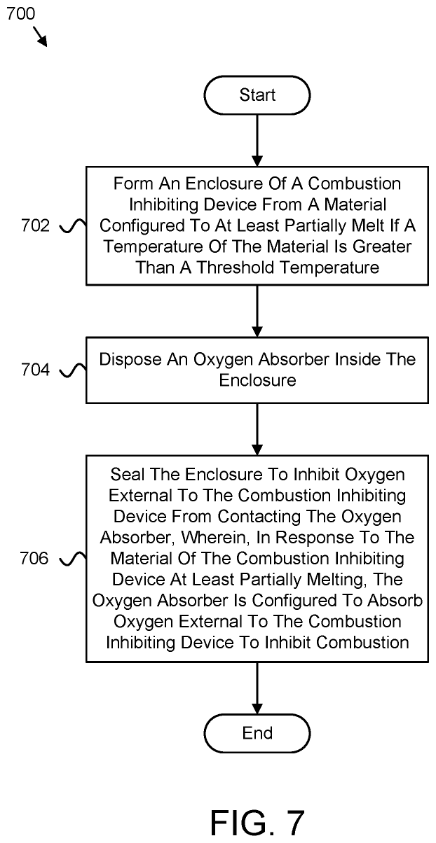

FIG. 7 is a schematic flow chart diagram illustrating an embodiment of a method 700 for manufacturing the combustion inhibiting device 104. In some embodiments, the method 700 is performed by a system, such as the system 400. In other embodiments, the method 700 may be performed by a different apparatus or system. In certain embodiments, the method 700 may be performed using a processor executing program code, for example, a microcontroller, a microprocessor, a CPU, a GPU, an auxiliary processing unit, a FPGA, or the like.

The method 700 may include forming 702 an enclosure of a combustion inhibiting device (e.g., the combustion inhibiting device 104) from a material (e.g., the material 302) configured to at least partially melt if a temperature of the material is greater than a threshold temperature. The enclosure may be formed using any suitable manufacturing process that produces the material in the shape of an enclosure (e.g., pouch). As may be appreciated, the material may be non-porous to inhibit oxygen from passing through the material. In some embodiments, the threshold temperature is greater than 100 degrees Celsius and less than 500 degrees Celsius. In other embodiments, the threshold temperature is greater than 200 degrees Celsius, greater than 300 degrees Celsius, less than 400 degrees Celsius, less than 600 degrees Celsius, and/or less than 800 degrees Celsius.

The method 700 may include disposing 704 an oxygen absorber (e.g., the oxygen absorber 304) inside the enclosure. The oxygen absorber may be disposed inside the enclosure using any suitable method, such as by pouring, depositing, dispensing, and so forth. Moreover, any manual and/or mechanical methods may be used to dispose the oxygen absorber inside the enclosure. In some embodiments, disposing 704 the oxygen absorber inside the enclosure includes substantially filling the enclosure with the oxygen absorber.

The method 700 may include sealing 706 the enclosure to inhibit oxygen external to the combustion inhibiting device from contacting the oxygen absorber. In some embodiments, in response to the material of the combustion inhibiting device at least partially melting, the oxygen absorber is configured to absorb oxygen external to the combustion inhibiting device to inhibit combustion. In certain embodiments, sealing 706 the enclosure includes substantially inhibiting the oxygen absorber from absorbing oxygen until the material of the combustion inhibiting device at least partially melts. Thus, after the oxygen absorber is disposed in the enclosure, the enclosure may be sealed at an open end so that there are no openings in the enclosure.

In various embodiments, sealing 706 the enclosure includes applying an adhesive to an open side (e.g., opening 406) of the enclosure (e.g., by applying an adhesive to the first upper side 402 and the second upper side 404 to join the first upper side 402 to the second upper side 404). In some embodiments, sealing 706 the enclosure includes applying heat to an open side (e.g., opening 406) of the enclosure (e.g., by applying heat to the first upper side 402 and/or the second upper side 404 to join the first upper side 402 to the second upper side 404). In certain embodiments, sealing 706 the enclosure includes adding the material to an open side (e.g., opening 406) of the enclosure (e.g., by adding the material to the first upper side 402 and/or the second upper side 404 to join the first upper side 402 to the second upper side 404). In various embodiments, sealing 706 the enclosure includes vacuum sealing the enclosure (e.g., removing any air and/or oxygen from the enclosure and sealing the opening 406 using any suitable method).

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a battery;
a combustion inhibiting device disposed adjacent to the battery, wherein
the combustion inhibiting device comprises:
a material forming an enclosure, wherein the material is configured to at least partially melt if a temperature of the material is greater than a threshold temperature; and
an oxygen absorber sealed inside the enclosure to inhibit oxygen external to the combustion inhibiting device from contacting the oxygen absorber, wherein, in response to the material of the combustion inhibiting device at least partially melting, the oxygen absorber is configured to absorb oxygen external to the combustion inhibiting device to inhibit combustion.

2. The system of claim 1, further comprising an information handling device comprising the battery and the combustion inhibiting device.

3. The system of claim 2, wherein the information handling device is selected from a group comprising a phone, a computer, and a tablet.

4. The system of claim 1, further comprising a container, wherein the battery and the combustion inhibiting device are disposed inside the container.

5. The system of claim 1, wherein the combustion inhibiting device is positioned around the battery.

6. A method comprising:
forming an enclosure of a combustion inhibiting device from a material configured to at least partially melt if a temperature of the material is greater than a threshold temperature;
disposing an oxygen absorber inside the enclosure; and
sealing the enclosure to inhibit oxygen external to the combustion inhibiting device from contacting the oxygen absorber, wherein, in response to the material of the combustion inhibiting device at least partially melting, the oxygen absorber is configured to absorb oxygen external to the combustion inhibiting device to inhibit combustion.

7. The method of claim 6, wherein the material is non-porous.

8. The method of claim 6, wherein the threshold temperature is greater than 100 degrees Celsius and less than 500 degrees Celsius.

9. The method of claim 6, wherein disposing the oxygen absorber inside the enclosure comprises substantially filling the enclosure with the oxygen absorber.

10. The method of claim 6, wherein sealing the enclosure comprises substantially inhibiting the oxygen absorber from absorbing oxygen until the material of the combustion inhibiting device at least partially melts.

11. The method of claim 6, wherein sealing the enclosure comprises applying an adhesive to an open side of the enclosure.

12. The method of claim 6, wherein sealing the enclosure comprises applying heat to an open side of the enclosure.

13. The method of claim 6, wherein sealing the enclosure comprises adding the material to an open side of the enclosure.

14. The method of claim 6, wherein sealing the enclosure comprises vacuum sealing the enclosure.

15. An apparatus comprising:
a material forming an enclosure, wherein the material is configured to at least partially melt if a temperature of the material is greater than a threshold temperature; and
an oxygen absorber sealed inside the enclosure to inhibit oxygen external to the apparatus from contacting the oxygen absorber, wherein, in response to the material of the apparatus at least partially melting, the oxygen absorber is configured to absorb oxygen external to the apparatus to inhibit combustion.

16. The apparatus of claim 15, wherein the material is non-porous.

17. The apparatus of claim 15, wherein the threshold temperature is greater than 100 degrees Celsius and less than 500 degrees Celsius.

18. The apparatus of claim 15, wherein the oxygen absorber substantially fills the enclosure.

19. The apparatus of claim 15, wherein the enclosure substantially inhibits the oxygen absorber from absorbing oxygen until the material of the apparatus at least partially melts.

20. The apparatus of claim 15, wherein the oxygen absorber is selected from a group comprising a liquid, a powder, and a plurality of pellets.
